(19) United States
(12) Patent Application Publication
(10) Pub. No.: US 2026/0178691 A1
(43) Pub. Date: Jun. 25, 2026

(54) SYSTEM AND METHOD FOR SEGREGATION OF DUTIES (SoD)

(71) Applicants: Martin Norman Artymiak, Old Saybrook, CT (US); Nicholas Gerard Hansen, Hamden, CT (US); Raul F. Lockhart, San Antonio, TX (US); Evan T. McDonnell, West Hartford, CT (US); Joseph M. Przechocki, Westfield, MA (US); Brittany H. Rogan, Manchester, CT (US)

(72) Inventors: Martin Norman Artymiak, Old Saybrook, CT (US); Nicholas Gerard Hansen, Hamden, CT (US); Raul F. Lockhart, San Antonio, TX (US); Evan T. McDonnell, West Hartford, CT (US); Joseph M. Przechocki, Westfield, MA (US); Brittany H. Rogan, Manchester, CT (US)

(21) Appl. No.: 18/987,097

(22) Filed: Dec. 19, 2024

(51) Int. Cl. G06F 17/16; H04L 67/306

(52) U.S. Cl. CPC G06F 17/16; H04L 67/306

(57) ABSTRACT

According to some embodiments, systems and methods are provided including receiving a Segregation of Duties (SoD) matrix, the SoD matrix including role-based rows and role-based columns, an identification of one or more cells having a toxic combination; converting the SoD matrix into a binary matrix, with the toxic combinations represented by “1”; transforming the binary matrix into a toxic combination matrix, including row-based rules, and role-based columns; receiving a user role report; generating a user role profile for each user in the user role report; determining, based on a dot product operation, the user role profile is a match or non-match for each of one or more rules in the toxic combination matrix; and in response to the determination, displaying a table including the one or more rules and one or more roles for which there was a determined match. Numerous other aspects are provided.

### BACKGROUND

Segregation of Duties (SoD), also known as “separation of duties” is an element of an organization's control system designed to prevent error and fraud. SoD controls are mandated by regulatory frameworks such as the Sarbanes-Oxley Act (SOX) to prevent fraud, errors and conflicts of interest. With SoD, different parts, including responsibilities, of a task or transaction are assigned to different people to reduce the risk of, and/or prevent, any one person from gaining sole or excessive control and then misusing that control for nefarious or unauthorized purposes, such as perpetrating fraud or embezzling enterprise funds. Toxic combinations pose a significant security risk to any organization, and identifying toxic combinations are a part of SoD controls. Toxic combinations are a combination of access rights which provide users with too great rights, posing a threat to organization security or compliance. A non-exhaustive example of a toxic combination is if one person can both create new vendors and approve payments. With this combination, they could potentially make fraudulent payments to fictious vendors. Another non-exhaustive example of a toxic combination is if a user can manage access permission and also delete system logs. With this combination, they can hide unauthorized access changes to data. Testing and maintaining effective SoD controls to manage SoD risk and significantly reduce the potential for abuse is a highly manual, labor-intensive process that may be prone to error.

It would therefore be desirable to provide systems and methods for improvements in processes relating to the control of Segregation of Duties. Moreover, results should be easy to access, understand, interpret, update, etc.

### SUMMARY OF THE INVENTION

According to some embodiments, systems and methods are provided to accurately and/or automatically identify which tables have been migrated to a cloud computing environment in a way that provides fast and useful results and that allows for flexibility and effectiveness when implementing those results.

Some embodiments are directed to segregation of duty (SoD) system implemented via a back-end application computer server. The system comprises an SoD data store that contains electronic records, each electronic record representing a role that may access an application; the back-end application computer server, coupled to the data store, including: a computer processor; and a computer memory, coupled to the computer processor, storing instructions that, when executed by the computer processor, cause the back-end application computer server to: receive a Segregation of Duties (SoD) matrix, the SoD matrix including role-based rows and role-based columns, an identification of one or more cells having a toxic combination; convert the SoD matrix into a binary matrix, with the toxic combinations represented by “1”; transform the binary matrix into a toxic combination matrix, including row-based rules, and role-based columns; receive a user role report; generate a user role profile for each user in the received user role report; determine the user role profile is a match or non-match for each of one or more rules in the toxic combination matrix; and in response to the determination, display, on a graphical user interface, a table including the one or more rules and one or more roles for which there was a determined match.

Some embodiments are directed to a computer-implemented method comprising: receiving a Segregation of Duties (SoD) matrix, the SoD matrix including role-based rows and role-based columns, an identification of one or more cells having a toxic combination; converting the SoD matrix into a binary matrix, with the toxic combinations represented by “1”; transforming the binary matrix into a toxic combination matrix, including row-based rules, and role-based columns; receiving a user role report; generating a user role profile for each user in the received user role report; determining, based on a dot product operation, the user role profile is a match or non-match for each of one or more rules in the toxic combination matrix; and in response to the determination, displaying, on a graphical user interface, a table including the one or more rules and one or more roles for which there was a determined match.

In some embodiments, a communication device associated with a back-end application computer server exchanges information with remote devices in connection with an interactive graphical interface. The information may be exchanged, for example, via public and/or proprietary communication networks.

A technical effect of some embodiments of the invention is an improved and computerized way to identify and monitor SoD conflicts (e.g., “toxic combinations”). With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a SoD framework in accordance with some embodiments.

FIG. 2 is a block diagram of an SoD process in accordance with some embodiments.

FIG. 3 illustrates a method in accordance with some embodiments.

FIG. 4 illustrates an SoD matrix and the transformation of the SoD matrix in accordance with some embodiments.

FIG. 5 illustrates a user interface in accordance with some embodiments.

FIG. 6 illustrates comparison of a user profile to each rule in accordance with some embodiments.

FIG. 7 illustrates a table including a results summary for a user in accordance with some embodiments.

FIG. 8 illustrates a first step of a dot product operation in accordance with some embodiments.

FIG. 9 illustrates a second step of the dot product operation based on the output in FIG. 8 in accordance with some embodiments.

FIG. 10 illustrates a user interface in accordance with some embodiments.

FIG. 11 illustrates a user interface in accordance with some embodiments.

FIG. 12 illustrates a user interface in accordance with some embodiments.

FIG. 13 is a block diagram of an apparatus or platform in accordance with some embodiments.

FIG. 14 illustrates a tablet computer display in accordance with some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data efficiency and usefulness associated with a SoD framework. The present invention is directed to more than merely a computer implementation of a routine or conventional activity previously known in the industry as it provides a specific advancement in the area of electronic record analysis by providing improvements in the operation of a computer system that facilitates the identification and monitoring of users with toxic role combinations. The present invention provides improvement beyond a mere generic computer implementation as it involves the novel ordered combination of system elements and processes to provide improvements in the speed and ease of such data retrieval and identification. Some embodiments of the present invention are directed to a system adapted to automatically identify users with toxic role combinations, monitor transactions by individuals with toxic role combinations, detect and report role discrepancies and potential toxic role combination requests. Embodiments may return a response to a user in real-time. Some embodiments of the present invention are directed to aggregate data from multiple data sources, to automatically optimize equipment information to reduce unnecessary messages or communications, etc. Moreover, communication links and messages may be automatically established, aggregated, formatted, exchanged, etc. to improve network performance (e.g., by reducing an amount of used network messaging bandwidth and/or storage required to implement such data retrieval, support technological updates, data collection, analysis, and distribution, etc.). For example, embodiments may reduce storage requirements by implementing a data in logic approach, as described below. The data in logic approach may also reduce an amount of used network messaging bandwidth as described further below.

As described above, toxic combinations are defined as a combination of access rights which provide users with too great rights, posing a threat to organization security or compliance. This toxic combination may also be referred to as an “SoD conflict” and may result when a user has multiple roles in a process, which allows them to perform a combination of activities that could potentially harm the integrity of the process by the user acting in their own interest and against the organization. Segregation of Duties (SoD) controls are employed to improve security and reduce the possibility of someone mis-using the control they have in a process for unethical purposes. Some of the key risks mitigated by SoD controls include, but are not limited to, security, fraud, misappropriation of assets, and misrepresentation of financial statements. With respect to security, without SoD controls, unauthorized access to sensitive information and systems increases the risk of data breaches and cyber-attacks. With respect to fraud, without SoD controls, fraudulent activities may be executed without appropriate escalation/notification (e.g., a single user initiates and approves a transaction). With respect to misappropriation of assets, without SoD controls, the lack of an adequate approval process subjects enterprise assets to misuse, mishandling or theft. With respect to misrepresentation of financial statements, undefined segregation of duties can lead to inaccuracies or intentional misstatements in financial reporting and increases the risk of financial and reputational impacts to the enterprise.

One way to prevent and/or mitigate an SoD conflict (“toxic combination”) is to implement role-based access control. Role-based access control is a method of restricting access based on the roles of individual users within the enterprise. Role-based access control parses levels of access to tasks and/or software applications based on a user's roles and responsibilities within the enterprise. An authorized person analyzes each role for both intra-role and inter-role SoD overlaps. Most conventional controls designed to manage SoD are highly manual and prone to errors. For example, an SoD control may define toxic role combinations according to enterprise and software application owners. The toxic role combinations may be defined in a SoD matrix. The SoD matrix maps out roles and responsibilities to ensure that duties are appropriately divided. The SoD matrix defines the types of roles that people are allowed to have and the roles they cannot have. The toxic role combinations may be defined to ensure that no single individual has control over all aspects of any critical process. This helps to prevent errors and fraud by dividing responsibilities among different people. An SoD steward or administrator monitors the SoD matrix for any changes. The SoD steward also monitors the activity of users with toxic role combinations to detect suspicious activity. The SoD matrix may be used to review and approve (or deny) requests for access to various systems and applications. The toxic role combination definitions may be updated as roles are added/modified.

Monitoring may also include the monitoring of user access requests for roles. A user may submit a user access request for a particular role in an application through which they may access a given application. These access requests may be reviewed one-by-one, by the SoS steward, for example, by manually scanning the requested role against the toxic role combinations in the SoD matrix. For example, when a user wants to newly access an application, a ticket (e.g., access request) is submitted, and then the application owner picks up the ticket, reviews the requested role, identifies what roles the user already has and determines whether there are any conflicts based on the newly requested access. It is noted that if a user requests a role that will result in a toxic combination, in some instances, the toxic role will be permitted. In those instances, the user is placed on a list and their activity in the application is then heavily monitored to make sure they are not doing anything nefarious. Also, due to the manual nature, there may be mistakes where toxic combinations are not defined in the SoD matrix itself or are not identified for a user, resulting in a potential backlog of unidentified toxic combinations. Given the complexity and number of roles involved, especially in large enterprises with numerous applications, the manual nature of these tasks is substantial. As a non-exhaustive example, an SoD control may include more than 90 roles and more than 50 toxic role combinations. Further, consider a single software application for which access is restricted. A monthly report describing users, roles and access requests for that application is compared to the SoD matrix to identify toxic combinations. That report may include over 7,500 users, 35,000 rows (with an average of four roles per user), and over 500 access requests. Each of these users, rows, roles and requests may be manually reviewed and monitored. In addition to conventional manual access request monitoring, regular SOX testing and external audit reviews verify compliance and effectiveness, requiring diligent oversight and continuous improvement to adapt to evolving processes and threats. As a non-exhaustive example, of the applications used by an enterprise, 72 of the applications may be considered “SOX applications” that are tested annually; each SOX application requires an SoD matrix and controls related to re-certification, secondary approval for toxic combinations, and ongoing monitoring. Continuing with this non-exhaustive example, a first SOX application has 19,450 active users, 99,000 rows in the Identity Manager (IM) report, 76 unique roles (making 2,850 role combinations), an average of 5 roles per user, more than 20 toxic combinations, and an average of 26 access requests per month. A second SOX application has 7,500 active users, 34,200 roles in the IM report, 220 unique roles (making 24,090 role combinations), an average of 4 roles per user, more than 50 toxic combinations, and an average of 500 access requests per month.

To address these problems, the SoD framework tool (SoD tool) provided by embodiments automatically and dynamically identifies users with toxic role combinations on-demand and in real-time. Pursuant to embodiments, the SoD tool generates a user profile for each user, using data from an Identity Manager Application Report (IM Report). An Oracle Identity Manager (OIM) report is a non-exhaustive example of an Identity Manager Application Report, generated by an OIM platform. The user profile is in the form of a table, where ones (1s) are the enabled (e.g., assigned) roles and zeros (0s) are the disabled (e.g., unassigned) roles for the user. The SoD tool also converts the SoD matrix into a binary table. The SoD tool then analyzes the user profile with respect to the binary table, to output whether any of the user roles have a conflict (e.g., are a toxic combination). The SoD framework outputs a list of users and their conflicting role combinations. The SoD framework may be executed on any toxic combination matrix and Identity Manager Application Report at any time. Pursuant to embodiments, in response to the SoD framework output, if access is not denied or revoked, actions performed by users with conflicting roles are automatically monitored.

Embodiments also provide for the use of “logic in data” vs. “logic in code,” enabling application of the SoD framework tool on any SoD matrix and identity management report with minimal changes to the program code. An SoD matrix may be created for each application. Conventionally, an enterprise may want a program code/script to check the user roles in the enterprise for toxic combinations. This code will cycle through all the users in the company via a “FOR” loop, and for each user, the code will use multiple IF statements to check for the toxic combinations (e.g., IF user has A and B, THEN conflict, ELSE . . . ; IF user has C and D, THEN conflict, ELSE . . . ; IF user has D and A, THEN conflict, ELSE . . . etc.). This is referred to as “logic in code”. In other words, the logic of what needs to be checked is included in the program code. While this logic in code approach would work, it would be slow. Additionally, including the logic in the program code requires changes to the program code any time there are changes to the SoD matrix. As non-exhaustive examples, changing the number of roles from five to four, or newly making two roles non-toxic, results in manual changes to all of the IF/ELSE statements in the “logic in code” approach. The use of “logic in code” also limits the program code to a given application. For example, the program code including logic (e.g., IF/ELSE statements) for specific roles A, B, C, D cannot be used with an application that has roles with different names because the program code is specific for a given SoD matrix, and cannot be used for different SoD matrices. Pursuant to one or more embodiments a “logic in data” approach is used instead of the “logic in code” approach. With the “logic in data” approach, the “logic” is in the data of the SoD matrix, as the “logic” is the pairs of potentially toxic combinations of roles to be checked. The “logic in data” approach used in one or more embodiments, includes the dynamic reading of the original SoD matrix, identifies the shaded cells which represent toxic combinations, and then treats those shaded cells as inputs for the calculations. Using the shaded cells from the SoD matrix as input eliminates the need for any hard-coded IF/ELSE statements specific to a given SoD matrix. The calculations executed by embodiments include a dot product technique to efficiently compare a user's profile against the SoD matrix, identifying any overlaps. The overlaps are indicative of a toxic combination. The “logic in data” approach may reduce storage requirements, as compared to a “logic in code” approach, as the “logic in data” approach avoids saving a program code for each SoD matrix. Compared to the “logic in code” approach, the “logic in data” approach may reduce bandwidth requirements by reducing the messages transmitted back-and-forth when a change is made to the SoD matrix. The “logic in data” approach provides for the SoD tool to flexibly configure toxic combinations by adjusting the matrix (e.g., the matrix may be updated as rules or policies evolve, without needing to re-write code). The SoD tool may be used for any SoD matrix, with defined roles and with a report that indicates the roles of each individual.

Embodiments further provide for real-time or near real-time checks for conflicts as roles are assigned or updated, reducing the likelihood of manual errors or delays in detecting SoD issues.

Embodiments also provide for the automated detection of users with toxic role combinations and the ability for integration with various Enterprise Resource Planning (ERP) system or identity management platforms to automate role assignment checks, and to monitor user activity, as described further below.

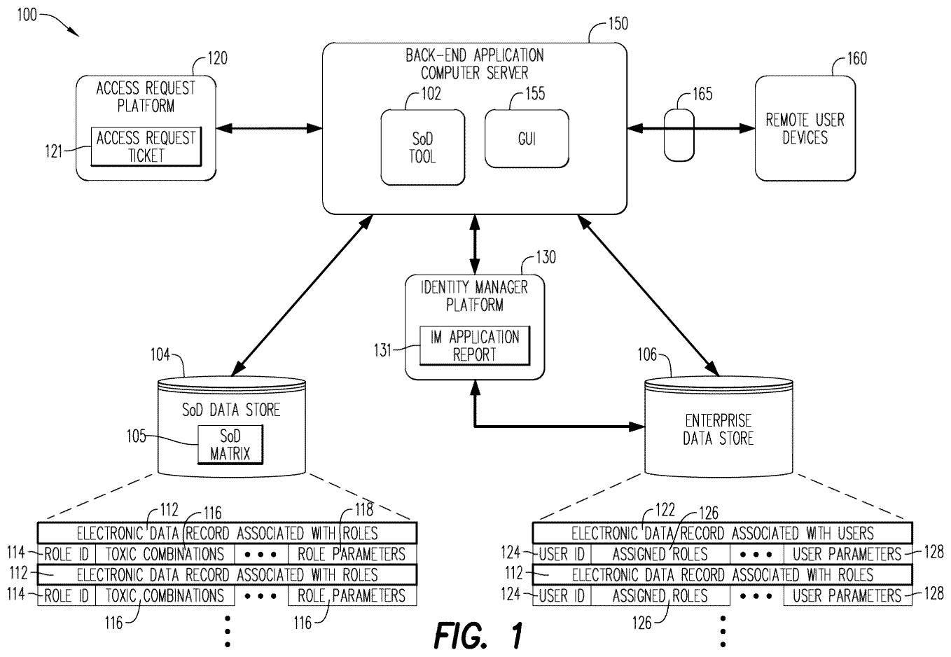

FIG. 1 is a high-level block diagram of a SoD framework or system 100 according to some embodiments of the present invention. In particular, the system 100 includes a back-end application computer server 150 and an SoD tool 102 that may access information in a SoD data store 104 (e.g., storing a set of electronic records representing roles 112 that may access an application, each record including, for example, one or more role identifiers 114, toxic combinations for the role 116, role parameters 118, etc.) and/or an enterprise data store 106 (e.g., storing a set of electronic records representing users 122, each record including, for example, one or more user identifiers 124, roles assigned to the user 126, user parameters 128, etc.). The SoD tool 102 may also retrieve information from other data stores or sources (e.g., access request data (e.g., access request tickets 121) from an access request platform 120, and an IM application report 131 from an identity manager platform 130) in connection with a Graphical User Interface (“GUI”) 155 to view analyze and/or update the electronic records. The SoD tool 102 may also exchange information with remote user devices 160 (e.g., via communication port that might include a firewall 165). In some embodiments, the remote user devices may transmit annotated and/or updated information to the back-end application computer server 150. Based on the updated information, the back-end application computer server 150 may adjust data in the SoD data store 104 and/or enterprise data store 106, and/or the change may be viewable via other remote devices. Note that the back-end application computer server 150 and/or any of the other devices and methods described herein might be associated with a cloud-based environment and/or a third party, such as a vendor that performs a service for an enterprise.

Presentation of a user interface via the GUI 155 may include any degree or type of rendering, depending on the type of user interface code generated by the back-end application computer server 150. For example, a user (not shown) may execute a Web Browser to request and receive a Web page (e.g., in HTML format) from back-end application computer server 150 via HTTP, HTTPS, and/or WebSocket, and may render and present the Web page according to known protocols.

The SoD tool 102 receives the SoD matrix 400 and interprets the toxic combinations in the SoD matrix 400 to create a set of rules. The SoD tool 102 may then use the set of rules to quickly analyze roles assigned to users for SoD violations. For example, the SoD tool 102 may convert the SoD matrix to a binary format. Embodiments provide for a unique application of a columnar arrangement with binary masking and matrix operations (dot product). In particular, the SoD matrix, which uses color-coded cells to mark toxic combinations, is converted to a binary format by the SoD tool. In the binary format, ones (1s) represent toxic combinations and zeros represent non-toxic roles. After the initial binary conversion, the SoD tool 102 transforms the binary format of the SoD matrix into a columnar format. Each row in this format represents a toxic combination based on the presence of ones (1s) in specific role columns. This transformation is able to handle toxic role combinations correctly input twice on the SoD matrix (e.g., roles A&B and roles B&A) or incorrectly input once (e.g., just role A&B is marked in the SoD matrix, but not B&A). The SoD matrix then applies a dot product operation to the columnar format and a user's role vector. The user's role vector is generated, by the SoD tool using the IM Report as input. Pursuant to embodiments, the dot product calculation is performed using Python's® NumPy (Numerical Python) module as np. dot (user_role_vector, unique_toxic_combinations_matrix. T) where the matrix transpose (denoted by . T) aligns the dimensions for the operation. The alignment produces a result vector that identifies entries where two roles from a toxic combination are simultaneously present in the user's profile, indicating a rule violation. For example, if the matrix marks roles A and D as a toxic combination, and the user has roles A, B and C, the dot product will identify that roles A and B of the user's profile are part of a toxic combination. By summing up the results, the SoD tool checks for instances where two or more roles from the same toxic combinations are present, ensuring user role conflicts are identified accurately. The inventors note that the use of the dot product is a key step in efficiently processing user roles against toxic combinations. For example, the combination of binary matrices and dot product operations are computationally inexpensive, making it feasible for use in enterprise environments with many roles and potential toxic combinations. As a non-exhaustive example, the SOD tool may analyze over 34,000 unique user and role combinations in a few minutes.

Data store 104/106 may be any query-responsive data source or sources that are or become known, including but not limited to a SQL relational database management system. Data store 104/106 may include or otherwise be associated with a relational database, a multi-dimensional database, an Extensible Markup Language (XML) document, or any other data storage system that stores structured and/or unstructured data. The data of data store 104/106 may be distributed among several relational databases, dimensional databases, and/or other data sources. Embodiments are not limited to any number or types of data sources. A structured query language (SQL) script may be generated based on a request for data and forwarded to the data store 104/106. The data store 104/106 may execute the SQL script to return a result set based on data of the data store 104/106.

The back-end application computer server 150 may store information into and/or retrieve information from the data store 104/106. The data store 104/106 may be locally stored or reside remote from the back-end application computer server 150. As will be described further below, the data store 104/106 may be used by the back-end application computer server 150 to access and update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and data store 104/106 might be co-located and/or may comprise a single apparatus and/or be implemented via a cloud-based computing environment.

The back-end application computer server 150 may be separated from or closely integrated with the data store 104/106. A closely integrated server 150 may enable execution of services completely on the database platform, without the need for an additional server. For example, back-end application computer server 150 may provide a comprehensive set of embedded services which provide end-to-end support for Web-based applications. The services may include a lightweight web server, configurable support for Open Data Protocol, server-side JavaScript execution and access to SQL and SQLScript. The back-end application computer server 150 may provide application services (e.g., via functional libraries) using services that mange and query the database files stored in the data store 104/106. The application services can be used to expose the database data model, with its tables, views and database procedures, to clients. In addition to exposing the data model, the back-end application computer server 150 may host system services such as a search service, and the like.

The back-end application computer server 150 and/or the other elements of the system 100 might be, for example, associated with a Personal Computer (“PC”), laptop computer, smartphone, an enterprise server, a server farm, and/or a data store or similar storage devices. According to some embodiments, an “automated” back-end application computer server 150 (and/or other elements of the system 100) may facilitate the automated access and/or update of electronic records in the SoD data store 104 and enterprise data store 106. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Note that the system 100 of FIG. 1 is provided only as an example, and embodiments may be associated with additional elements or components. According to some embodiments, the elements of the system 100 automatically transmit information associated with an interactive user interface display over a distributed communication network.

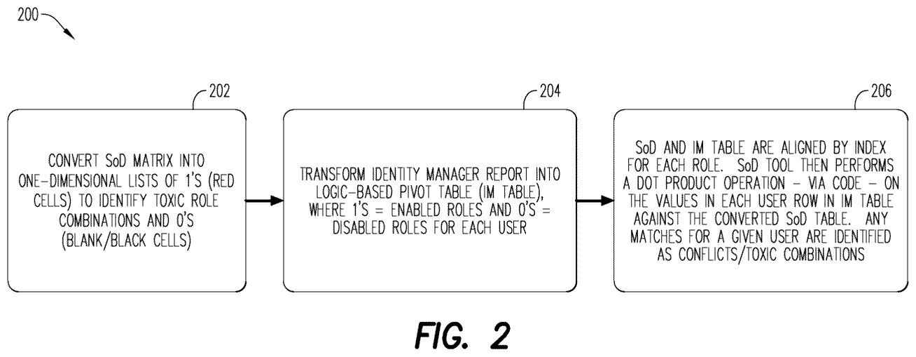

FIG. 2 illustrates a high-level block diagram 200 to identify any toxic roles for a given user. At 202, the SoD matrix is converted into one-dimensional lists of ones (1s), which may represent red (or any suitable color) cells from the SoD matrix and mark the toxic role combinations and zeros (0s), which may represent blank or black cells from the SoD matrix. Representing the red cells as ones (1s) and other cells as zeros (0s) provides for the inclusion of the cells in calculations, facilitating the identification of toxic combinations. Then, at 204, the IM report is transformed into a logic-based pivot table (“IM table”), where ones (1s) are the enabled roles and zeros (0s) are the disabled roles for each user. As described above, an enabled role is a role assigned to the user, and a disabled role is a role that is not assigned to the user. Next, at 206, the converted SoD matrix and the IM table are aligned by index for each role. The SoD tool 102 then performs a dot product operation—via code—on the values in each user row in the IM table against the values in the converted SoD table. The SoD tool 102 then identifies any instances of matches for the user as conflicts/toxic combinations.

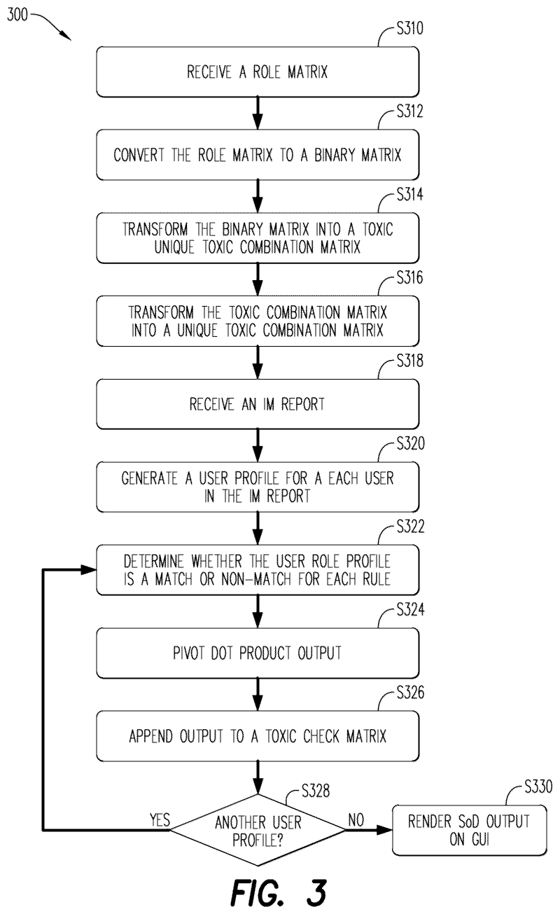

FIG. 3 and illustrates a process 300 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

FIG. 3 comprises a flow diagram of a process 300 to identify toxic combinations for a user according to some embodiments. Process 300 and other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

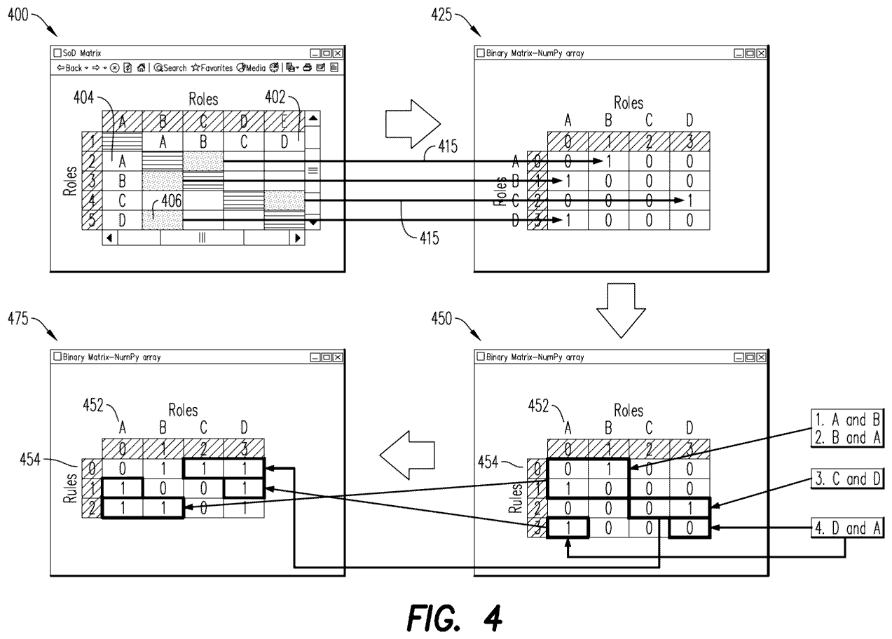

Prior to the process 300, an SoD matrix 105 is generated. The SoD matrix 105 may be generated by an administrator or other suitable party. Pursuant to one or more embodiments, the SoD matrix 105 may be a spreadsheet or other suitable table organized into rows and columns. In one or more embodiments, the SoD matrix may be structured by bundle or layered permission, making conventional conflict identification more difficult. FIG. 4 includes a non-exhaustive simple example of an SoD matrix 400. The SoD matrix 400 lists the roles in the first row 402 and the first column 404. These are the individual roles for an application that can be granted to an individual user. For ease of explanation, here the roles are listed A, B, C, D. In other SoD matrices, the roles may be listed as analytics editor, administrator, supervisor, manager, etc. or any other suitable role. All of the shaded cells (in some instances, they will be shaded red), indicate a toxic combination. For example, if the user has Role A, they can't have Role B, because that's a toxic combination. It is noted that the SoD matrix may have mirror symmetry along the A-A, B-B, C-C, D-D diagonal (marked by stripes herein) because if A and D is toxic, then D and A is also toxic. In some instances, the A-A, B-B, C-C, D-D diagonal may be blacked out because this role “combination” is non-sensical as it is the same role. As described above, the identification of the toxic combinations is to prevent a user having the ability for straight through processing. For example, if a user has administrative processing such that their task is managing other people's access to an application (e.g., giving them access/changing their access), typically these users are not also processing a claim. Another example of a toxic combination would be a user with an administrative role that manages logical access and a role with the ability to submit and approve a claim, so the user would have the ability to do straight through processing.

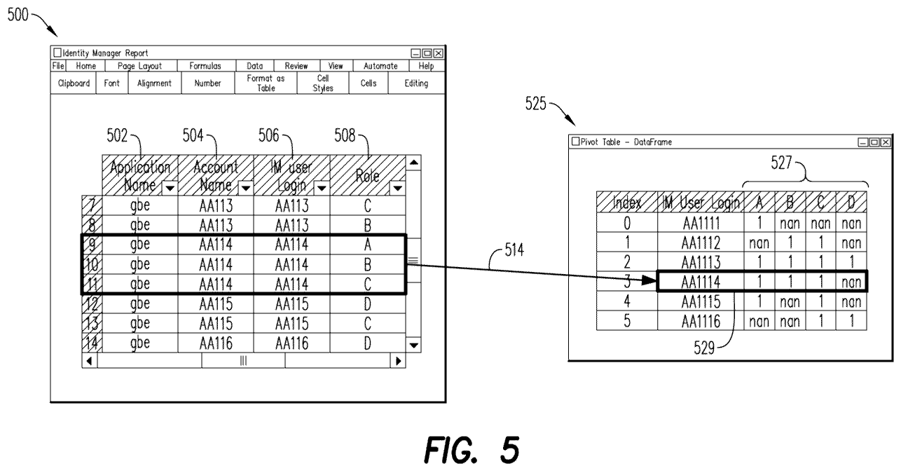

Also prior to the process, an IM report 131 (user role report) is generated by the identity management platform 130. The identity management (IM) platform 130 is a tool that helps organizations manage user identities and access to resources across their enterprise. IM platform 130 manages the entire lifecycle of user identities, including provisioning, administration and password management. As the roles are assigned to users by the IM platform 130, the enterprise data store 106 may be updated with those role assignments. The IM platform 130 helps enterprises manage user access and entitlements to applications, both on-premise and in the cloud. The IM report 131 lists all the users for a given application. Each row of the IM report 131 lists the user and their role. For example, if a user has five different roles, they'd be listed five times in the IM report 131. FIG. 5 includes a non-exhaustive example of an IM report 500. The IM report 500 includes the following columns: application name 502, account name 504, IM user login 506 and role 508. Other suitable columns may be included in the IM report 500. As described above, an application may have thousands of users with a lot of roles, and 500 or more access changes in a given month, making it difficult to manually manage SoD risk when users are constantly changing roles, presenting the opportunity for them to have a toxic combination.

Pursuant to embodiments, the process 300 may be initiated via a schedule. For example, the process may be scheduled to run every minute, every week, every month, etc. Pursuant to embodiments, the process 300 may be initiated in response to the access request platform 120 receiving an access request ticket 121. The process 300 may be directly integrated with the application and access request process to prevent roles from being granted, or to validate the access after the role has been granted.

Initially, at S310, an SoD matrix (“role matrix”) 400 is received. The SoD tool 102 receives the SoD matrix 400 interprets the toxic combinations in the SoD matrix 400 to create a set of rules. The SoD matrix 400 may then use the list of rules to quickly analyze roles assigned to users for SoD violations.

Turning back to the non-exhaustive example in FIG. 4, and as described above, the SoD matrix 400 includes four roles in the rows 402 and the same four roles in the columns 404, and toxic combinations 406 indicated by the shading.

Next, at S312, the SoD matrix 400 is converted, via the SoD tool 102, into a binary matrix 425 (FIG. 4). The binary matrix 425 may be in a Numerical Python (NumPy) array format, which is a fundamental data structure in the NumPy library. The NumPy array is implemented in C, making it faster than Python lists for numerical computations. The NumPy library contains multidimensional array data structures, such as the homogeneous, N-dimensional ndarray, and a large library of functions that operate efficiently on these data structures. The binary matrix 425 represents the shaded cells/toxic combinations from the SoD matrix as ones (1s), and the non-toxic cells as zeros (0s). In FIG. 4, the arrows 415 show the conversion of the toxic combinations from the SoD matrix 400 to the binary matrix 425. The binary matrix 425, like the SoD matrix, is a cross-reference type matrix where the rows and columns represent the roles. Here, the toxic combinations are identified as: 1. A and B, 2. B and A, 3. C and D, and 4. D and A. It is noted that while D and A is identified as a toxic combination, A and D is not identified toxic combination. Similarly, C and D is identified as a toxic combination, but D and C is not identified as a toxic combination. It is possible that the generated SoD matrix includes inaccuracies (e.g., not marking D and C as toxic, not marking A and D as toxic, etc.). As described above, the binary matrix enforces mirror symmetry, and will correct these “missing” toxic combinations. As long as one of the combinations is identified as toxic, the SoD tool will identify the mirror symmetry combination on the other side of the diagonal as also being toxic, to enforce the mirror symmetry. This enforcement of the mirror symmetry by the SoD tool 102, addresses the manual error of an SoD matrix used in conventional toxic combination identifications.

Then, in S314, the binary matrix is transformed, via the SoD tool 102, into a toxic combination matrix 450 (FIG. 4). In the toxic combination matrix 450, the columns represent roles 452, while the rows represent the rule 454 for each toxic combination. A one (1) means that role is part of a toxic combination. As a result of S314, the toxic combinations are transformed into row-based logic rules, whereby each row represents a rule, and each column represents a role. In this way, every toxic combination (colored cell in the SoD matrix 400) is represented by a row. By only including the toxic combinations for comparison described further below, as compared to checking every combination (toxic and non-toxic), embodiments reduce the system's used bandwidth.

Duplicate toxic combinations are removed from the toxic combination matrix 450 in S316, resulting in the transformation of the toxic combination matrix 450 to the unique toxic combination matrix 475 (FIG. 4). Only unique toxic combinations are kept, so that the SoD tool 102 does not waste time checking duplicates, also reducing used bandwidth. The SoD tool 102 identifies any missing roles (e.g., to enforce mirror symmetry), and then condenses the rules to create a unique list of toxic combinations for the SoD tool 102 to identify. The rows of the unique toxic combination matrix 475 are sorted numerically. Continuing with the non-exhaustive example, the duplicate of A and B (B and A) is removed from the toxic combination matrix 450 to form the unique toxic combination matrix 475. In the unique toxic combination matrix 475, each row represents a rule 454, and each column represents a role 452.

Then, in S318, an IM report (“role report”) is received. As described above, and shown in FIG. 5, the IM report 500 lists users and their roles for a specific application. In one or more embodiments, the IM report 500 includes the following columns: application name 502, account name 504, IM user login 506 and role 508. Other suitable columns may be included in the IM report 500. Each unique row represents one user and one rule, such that users with multiple roles will appear in multiple rows. Taking IM user login 506 AA1114, as an example, this user (“George”) has 3 roles—A, B and C.

A user role profile 529 is generated in S320 for each user in the IM report. Pursuant to embodiments, to generate the user profile, the SoD tool 102 pivots the IM report on role, resulting in a pivot table 525. The pivot table 525 shows all the roles 527 across the top, such that all the roles a user has are in a single row. In this way, the IM report is used to bring in each user's role profile. Each row represents a user role profile 529, and a one (1) indicates the user has that role. The arrow 514 shows the pivot for user AA1114 from the IM report 500 to the representation in the pivot table 525. The user role profile 529 for George, has a one (1) in each of columns A, B and C. George does not have role D, so that cell may be left blank or have some other indication of unavailability (e.g., nan).

The user role profile 529 is then compared to each of the rules 454 in the unique toxic combination matrix 475 in S322 to determine whether the user role profile is a match or non-match for each of the one or more rules in the unique toxic combination matrix.

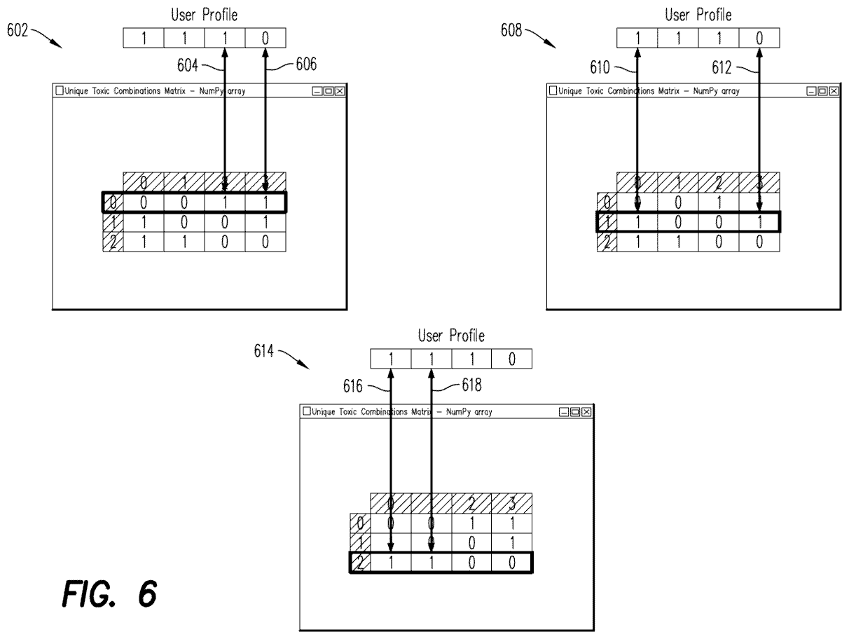

Continuing with the non-exhaustive example, FIG. 6 includes the comparison of each rule 454 to the user role profile 529 for George. The user role profile 529 for George is [1,1,1,0]. For the first rule 602, George's user role profile is a non-match. In particular, for the first rule 602, roles C and D are a toxic combination represented by ones (1s) in the matrix. While George has role C (represented by one in the profile), he does not have role D (represented by zero in the profile), the comparison indicated by arrows 604 and 606, respectively, so this is not a toxic combination for George. For the second rule 608, George's user role profile is a non-match. In particular, for the second rule 608, roles A and D are a toxic combination, represented by ones (1s) in the matrix. While George has role A (represented by one in the profile), he does not have role D (represented by zero in the profile), the comparison indicated by arrows 610 and 612. For the third rule 614, George's user role profile is a match. In particular, for the third rule 614, roles A and B are a toxic combination (represented by ones in the matrix). George has roles A, B and C, (each represented by one in the profile) and thus the toxic combination of roles A and B, the comparison indicated by arrows 616 and 618.

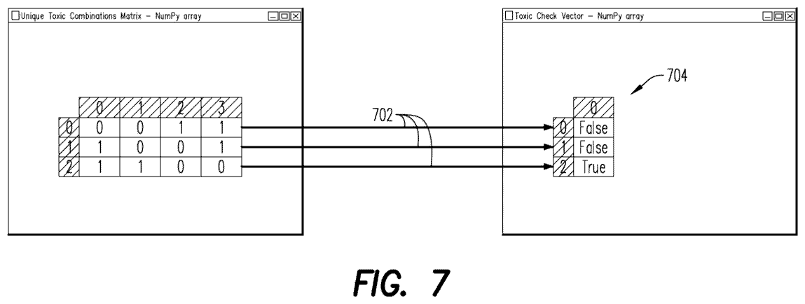

Pursuant to one or more embodiments, the SoD tool 102 performs the comparison of the user role profile 529 to each of the rules 454 in the unique toxic combination matrix 475 in S322 via a dot product operation 702 (FIG. 7). The dot product operation 702 performs multiplication and addition in a single operation. The dot product operation 702, pursuant to embodiments, uses a linear algebra function. The dot product operation 702 adds and multiplies the results of a vector (the user profile) against the unique combination matrix. The use of the binary matrix and dot product operation provided by one or more embodiments is advantageous in that there may be many thousands of rows to analyze for potential toxic combinations, a task that cannot practically be performed by the human mind in a reasonable amount of time, and the single dot product operation is called once and the operation is performed quickly. As described above in a non-exhaustive example, the SoD tool 102 may analyze over 34,000 unique user and role combinations for a given application in a few minutes, as compared to the conventional many hours of manual checking. The output of the dot product operation is a value of “False” for a non-match (e.g., not a toxic combination) and “True” for a match (e.g., a toxic combination). Application of the dot product operation 702 identifies the people with a toxic combination via a “True” output. Turning to FIG. 7 and continuing with the non-exhaustive example for George's user role profile having roles A, B and C but not D, the dot product operation 702 is applied to the unique toxic combination matrix 475 for George, and the output 704 is a toxic check vector, indicating “False” for the first rule 602, “False” for the second rule 608 and “True” for the third rule 614.

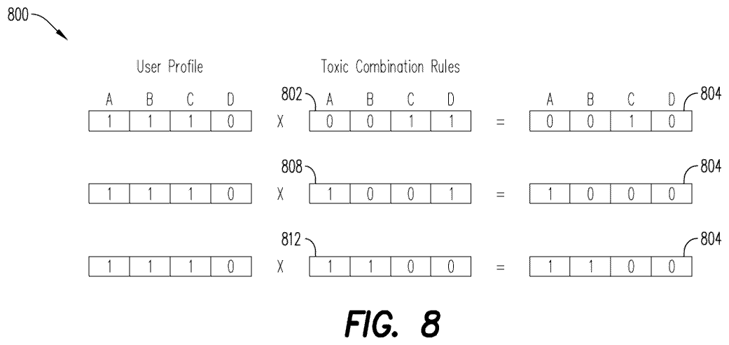

FIG. 8 shows the application of the multiplication part 800 of the dot product operation 702 to each of the rules in the non-exhaustive example. The multiplication of a single user's role profile by multiple toxic combination rules to calculate a result is the multiplication part 800 of the dot product operation. In particular, George's user role profile is multiplied by each of the rules in the unique toxic combination matrix 475. For the first rule 802, the multiplication output 804 is [0, 0, 1, 0] because: A*A, which is (1*0) is 0, B*B, which is (1*0) is 0, C*C, which is (1*1) is 1, and D*D, which is (0*1) is 0. For the second rule 808, the multiplication output 804 is [1, 0, 0, 0] because: A*A, which is (1*1) is 1, B*B, which is (1*0) is 0, C*C, which is (1*0) is 0, and D*D, which is (0*1) is 0. For the third rule 812, the multiplication output 804 is [1, 1, 0, 0] because: A*A, which is (1*1) is 1, B*B, which is (1*1) is 1, C*C, which is (1*0) is 0, and D*D, which is (0*0) is 0. This process is iterated for each rule.

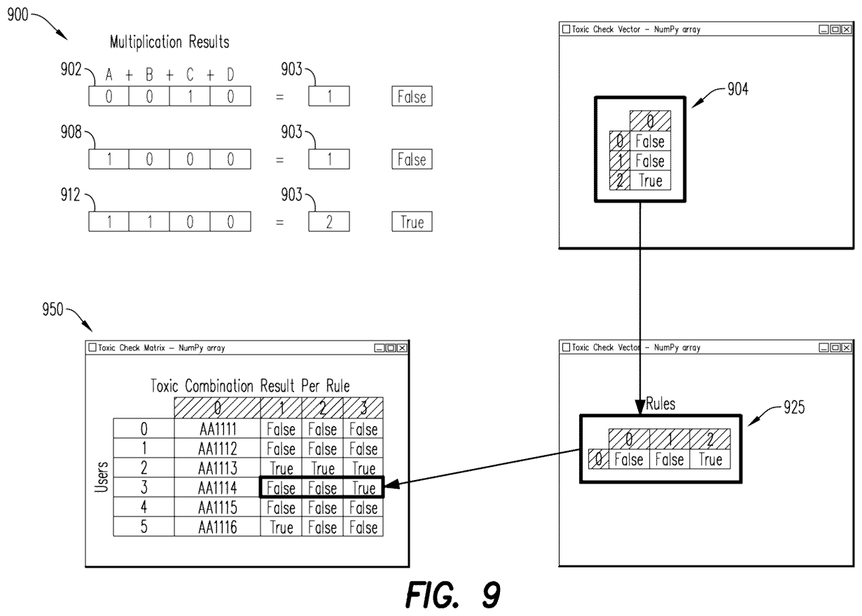

FIG. 9 shows the application of the addition part 900 of the dot product operation 702 to the multiplication output 804 for each of the rules applied to George's user role profile. The addition part 900 is the second step of the dot product, and sums horizontally the calculated result from FIG. 8 resulting in a one (1) for False or a two (2) for True. An answer of two (2) or more is “True” and a match (e.g., toxic combination). It is noted that two or more is a toxic combination because two (or more) roles are going to result in a toxic combination (e.g., toxic combinations are defined as two roles in conflict). An answer of zero (0) or one (1) is “False” and a non-match (e.g., non-toxic combination). For the first rule 902, the equation result 903 is one (1) because: A+B+C+D is 0+0+1+0, which is one (1). An equation result 903 of one (1) is represented as “False”. For the second rule 908, the equation result 903 is one (1) because A+B+C+D is 1+0+0+0, which is one (1). For the third rule 912, the equation result 903 is two (2) because A+B+C+D is 1+1+0+0, which is two (2). An equation result 903 of two (2) is represented as “True”. As described above, the output 904 of the dot product operation 702 is a toxic check vector that may be stored as an array (e.g., NumPy array). Here, the output 904 is a toxic check vector with values of False, False, True.

The inventors note that the use of the dot product operation 702 is advantageous as dot product operations are a concept built into vector calculus, and many programming languages have a code for this concept. As such, by invoking, per the SoD tool 102, the dot product from the columnar form of the SoD matrix against a particular user's role profile with one call/command (e.g., a SQL command), that single dot product command will automatically loop through all of the multiplication and addition for all of the rules for each of the users. As described above, while the non-exhaustive example described herein is for a single user (George) and only three rules, each application may have many thousands of users, and many roles and combinations for each user. As a non-exhaustive example, the SoD tool 102 may analyze over 34,000 unique user and role combinations for a given application in a few minutes, as compared to the conventional many hours of manual checking.

Turning back to the process 300, the dot product output (e.g., the toxic check vector array) is pivoted to generate a pivoted toxic check vector array 925 (e.g., NumPy array), via the SoD tool 102, in S324, with each column representing a rule. Again, “True” means George's role profile was identified as a toxic combination because of the third rule.

Then in S326, the output in the pivoted toxic check vector array 925 is appended to a toxic check matrix 950. In the toxic check matrix 950, each column represents a role and each row represents each user, and will have a “True” for every toxic combination rule that was a match.

The process 300 then proceeds to S328 and it is determined whether another user profile exists for analysis. In a case it is determined at S328 that another user profile does exist, the process returns to S322. The determination is based on the users in the IM report. In a case it is determined at S328 that another user profile does not exist, the process proceeds to S330 and the output of the SoD tool including the users having toxic conflicts is exported and rendered on a graphical user interface display. The output of the SoD tool 102 may be a table including the one or more rules for which there was a determined match (e.g., toxic combination) and a count of the matches for each rule.

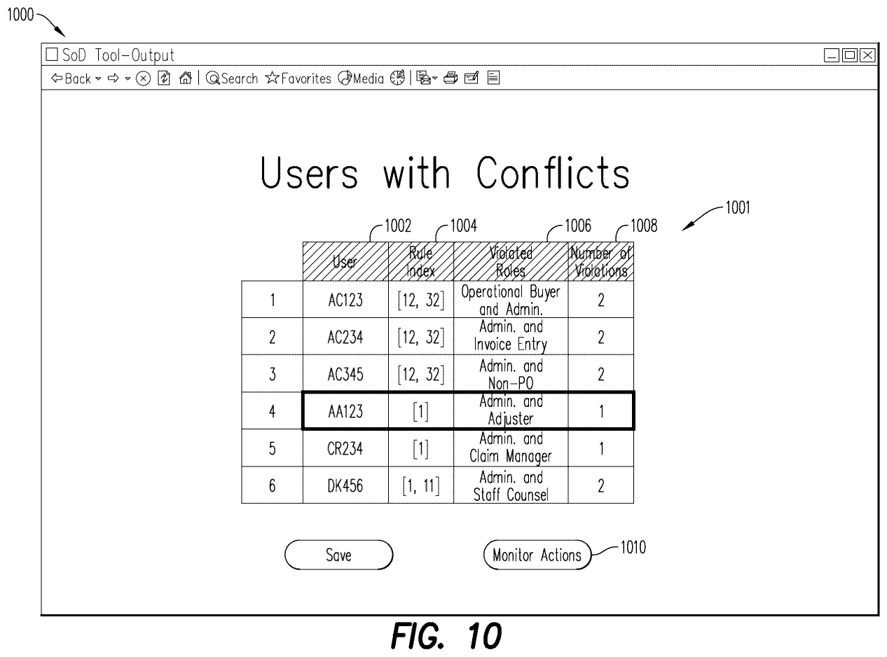

For example, FIG. 10 is a users with conflicts user interface 1000 including table 1001 according to some embodiments. The users with conflicts table 1001 is a non-exhaustive example of the output of the SoD tool 102. The users with conflicts table 1001 includes a user column 1002 indicating the users having at least one toxic combination, a rule index column 1004 indicating the rule number violated by the given user, a violated roles column 1006 indicating the roles having the conflict, and a number of violations column 1008 indicating the number of toxic conflicts identified for the given user. Selection of a “Monitor Actions” icon 1010 initiates a monitoring process. As described above, in some instances it is permitted to have a toxic combination with further monitoring. Here, user AA123 is selected, as indicated by the dark rectangle, for further monitoring via selection of the “Monitor Actions” icon 1010.

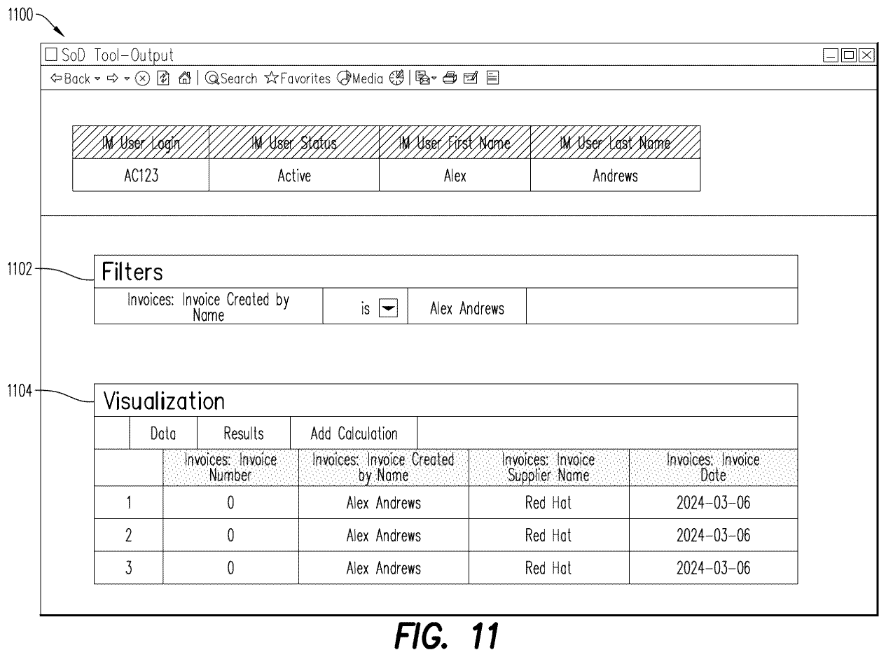

As part of the monitoring process, a monitoring user interface 1100 is provided in FIG. 11 according to some embodiments to monitor the actions of one or more users. In the non-exhaustive example herein, a filter 1102 is selected to review a given user, in this case Alex Andrews, corresponding to AA123 selected in FIG. 10. Pursuant to embodiments, the system then retrieves the actions/transactions the user has performed from an action data warehouse (e.g., a claims data warehouse) and renders them on the monitoring user interface 1100. Here, the invoices created by Alex Andrews are the monitored actions/transactions, and data associated with the invoices is displayed in visualization 1104. While invoices are monitored herein, other suitable actions may be monitored. The visualization 1104 includes an invoice number, an invoice creator, an invoice supplier and an invoice date for each entry.

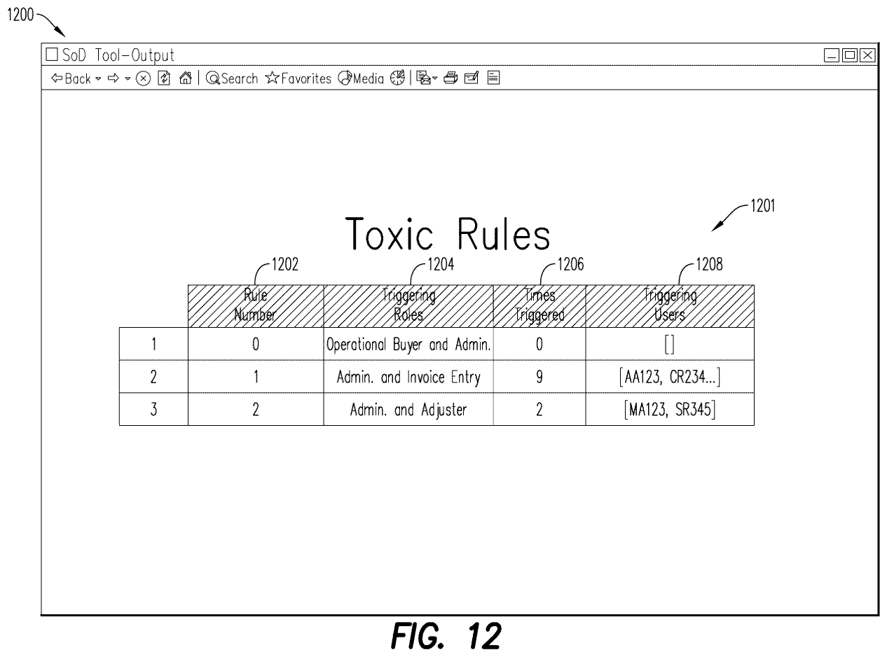

As another example of an SoD output, FIG. 12 is a toxic rules user interface 1200 including a toxic rules table 1201 according to some embodiments. The toxic rules table 1201 includes a rule number column 1202, indicating the number for the violated rule, a triggering roles column 1204 indicating the roles associated with the rule, a times triggered column 1206 indicating the number of times the rule was violated (e.g., matched), and a triggering users column 1208 indicating the users whose roles matched the rule (e.g., toxic combination).

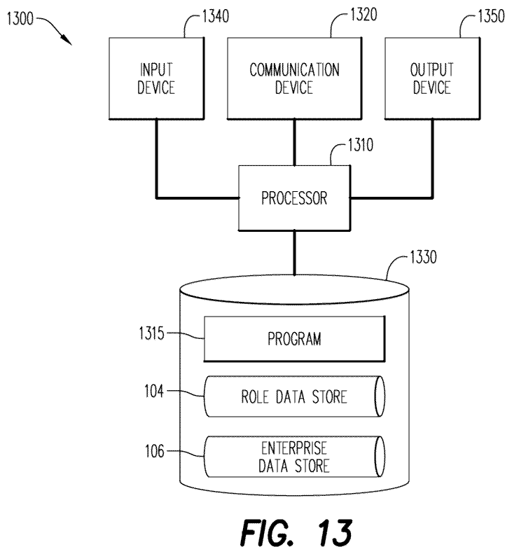

The embodiments described herein may be implemented using any number of different hardware configurations. For example, FIG. 13 illustrates an apparatus 1300 that may be, for example, associated with the system 100 described with respect to FIG. 1. The apparatus 1300 comprises a processor 1310, such as one or more commercially available Central Processing Units (“CPUs”) in the form of one-chip microprocessors, coupled to a communication device 1320 configured to communicate via a communication network (not shown in FIG. 13). The communication device 1320 may be used to communicate, for example, with one or more remote third-party business or economic platforms, administrator computers, insurance agent, and/or communication devices (e.g., PCs and smartphones). Note that communications exchanged via the communication device 1320 may utilize security features, such as those between a public internet user and an internal network of an insurance company and/or an enterprise. The security features might be associated with, for example, web servers, firewalls, and/or PCI infrastructure. The apparatus 1300 further includes an input device 1340 (e.g., a mouse and/or keyboard to enter information about data sources, toxic combinations, role definitions, etc.) and an output device 1350 (e.g., to output reports regarding toxic combinations, rule violations, etc.).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1315 and/or an application for controlling the processor 1310. The processor 1310 performs instructions of the program 1315, and thereby operates in accordance with any of the embodiments described herein. For example, the processor 1310 may a receive a request for identification of any users having toxic combinations for a given application. The processor 1310 may then automatically generate a list of toxic combinations in response to the received request.

The program 1315 may be stored in a compressed, uncompiled and/or encrypted format. The program 1315 may furthermore include other program elements, such as an operating system, a database management system, and/or device drivers used by the processor 1310 to interface with peripheral devices.

As used herein, information may be “received” by or “transmitted” to, for example: (i) the apparatus 1300 from another device; or (ii) a software application or module within the apparatus 1300 from another software application, module, or any other source.

In some embodiments (such as shown in FIG. 13), the storage device 1330 further includes a SoD data store 104 and enterprise data store 106.

Thus, some embodiments may provide improved toxic combination evaluation and monitoring. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

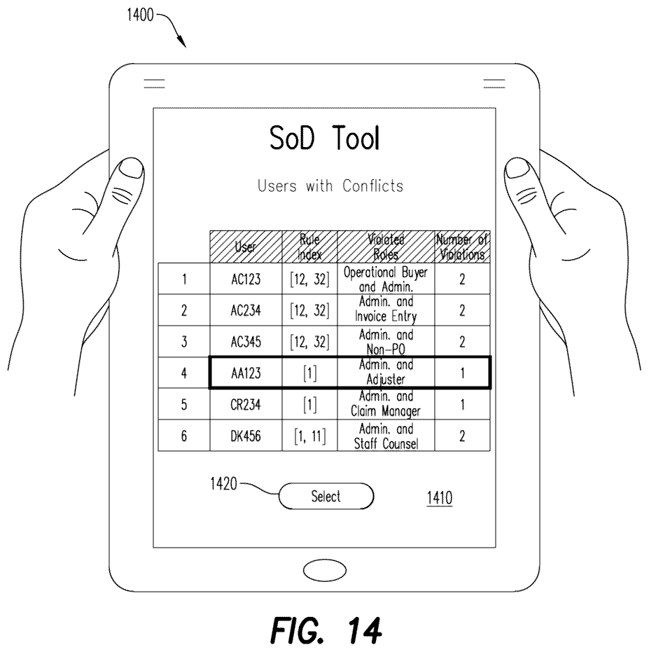

Although specific hardware and data configurations have been described herein, note that any number of other configurations may be provided in accordance with embodiments of the present invention (e.g., some of the information associated with the displays described herein may be implemented as a virtual or augmented reality display and/or the database described herein may be combined or stored in external systems.) Moreover, although embodiments have been described with respect to particular types of enterprises (e.g., an insurance company), embodiments may instead be associated with other types of businesses in addition to and/or instead of those described herein (e.g., financial institutions, universities, governmental departments, etc.). Similarly, although certain attributes were described in connection with some embodiments herein, other types of attributes may be used instead. Sill further, the displays and devices illustrated herein are only provided as examples and embodiments may be associated with any other types of user interfaces. For example, FIG. 14 illustrates a handheld tablet computer 1400 showing a User with Conflicts display 1410 according to some embodiments. The User with Conflicts display 1410 may include users that have toxic combinations that can be selected and/or modified by a user of the handheld computer 1400 (e.g., via a “Select” icon 1420) to send a notification (e.g., e-mail) to the user, to initiate further monitoring of the user-actions, etc. The User with Conflicts display 1410 may allow an administrator to see which users currently have conflicted roles or which users would have conflicted roles if their access requests were granted. This may help administrators manage toxic combinations.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A segregation of duty (SoD) system implemented via a back-end application computer server, comprising:
a SoD data store that contains electronic records, each electronic record representing a role that may access an application;
the back-end application computer server, coupled to the data store, including:
a computer processor; and
a computer memory, coupled to the computer processor, storing instructions that, when executed by the computer processor, cause the back-end application computer server to:
receive a Segregation of Duties (SoD) matrix, the SoD matrix including role-based rows and role-based columns, an identification of one or more cells having a toxic combination;
convert the SoD matrix into a binary matrix, with the toxic combinations represented by “1”;
transform the binary matrix into a toxic combination matrix, including row-based rules, and role-based columns;
receive a user role report;
generate a user role profile for each user in the received user role report;
determine the user role profile is a match or non-match for each of one or more rules in the toxic combination matrix; and
in response to the determination, display, on a graphical user interface, a table including the one or more rules and one or more roles for which there was a determined match.

2. The system of claim 1, wherein the determination whether the user role profile matches one or more rules in the toxic combination matrix is based on a dot product operation.

3. The system of claim 2, wherein the dot product operation is iterated for each user in the user role report.

4. The system of claim 1, wherein a mirror symmetry identification changes a representation of a cell not identified as having the toxic combination to a toxic combination representation.

5. The system of claim 1, wherein the each row in the toxic combination matrix represents a rule of the row-based rules for each toxic combination.

6. The system of claim 1, further comprising instructions to cause the back-end application computer server to:
remove duplicate toxic combinations from the toxic combination matrix, resulting in generation of a unique toxic combination matrix.

7. The system of claim 6, wherein the unique toxic combination matrix is generated prior to determining the user role profile is a match or non-match.

8. The system of claim 1, wherein the user role report includes one or more users and their respective roles for a given application.

9. The system of claim 8, wherein the received user role report includes a plurality of unique rows, and each unique row represents one user and one role.

10. The system of claim 1, further comprising instructions to cause the back-end application computer server to, prior to generation of the user role profile:
pivot the user role report on role, wherein the pivoted user role report includes row-based users and column-based roles, and a mark for each user-role match.

11. A computer-implemented method comprising:
receiving a Segregation of Duties (SoD) matrix, the SoD matrix including role-based rows and role-based columns, an identification of one or more cells having a toxic combination;
converting the SoD matrix into a binary matrix, with the toxic combinations represented by “1”;
transforming the binary matrix into a toxic combination matrix, including row-based rules, and role-based columns;
receiving a user role report;
generating a user role profile for each user in the received user role report;
determining, based on a dot product operation, the user role profile is a match or non-match for each of one or more rules in the toxic combination matrix; and
in response to the determination, displaying, on a graphical user interface, a table including the one or more rules and one or more roles for which there was a determined match.

12. The method of claim 11, wherein the dot product operation is iterated for each user in the user role report.

13. The method of claim 11, wherein a mirror symmetry identification changes a representation of a cell not identified as having the toxic combination to a toxic combination representation.

14. The method of claim 11, wherein the each row in the toxic combination matrix represents a rule of the row-based rules for each toxic combination.

15. The method of claim 11, further comprising:
removing duplicate toxic combinations from the toxic combination matrix, resulting in generation of a unique toxic combination matrix.

16. The method of claim 11, wherein the user role report includes one or more users and their respective roles for a given application.

17. The method claim 16, wherein the received user role report includes a plurality of unique rows, and each unique row represents one user and one role.

18. One or more non-transitory computer-readable media storing program code that, when executed by a computing system, causes the computing system to perform operations comprising:
receiving a Segregation of Duties (SoD) matrix, the SoD matrix including role-based rows and role-based columns, an identification of one or more cells having a toxic combination;
converting the SoD matrix into a binary matrix, with the toxic combinations represented by “1”;
transforming the binary matrix into a toxic combination matrix, including row-based rules, and role-based columns;
receiving a user role report;
generating a user role profile for each user in the received user role report;
determining, based on a dot product operation, the user role profile is a match or non-match for each of one or more rules in the toxic combination matrix; and
in response to the determination, displaying, on a graphical user interface, a table including the one or more rules and one or more roles for which there was a determined match.

19. The medium of claim 18, wherein the dot product operation is iterated for each user in the user role report.

20. The medium of claim 18, wherein the each row in the toxic combination matrix represents a rule of the row-based rules for each toxic combination.
